(19) United States
(12) Patent Application Publication
(10) Pub. No.: US 2006/0174448 A1
(43) Pub. Date: Aug. 10, 2006

(54) Pen-holding posture corrective apparatus

(76) Inventor: Mong-Chien You, Keelung City (TW)

Correspondence Address: BIRCH STEWART KOLASCH & BIRCH, PO BOX 747, FALLS CHURCH, VA, 22040-0747, US

(21) Appl. No.: 11/052,197

(22) Filed: Feb. 8, 2005

(51) Int. Cl. B25G 1/10

(52) U.S. Cl. 16/430

(57) ABSTRACT

A pen-holding corrective apparatus is formed with at least a plurality of poisitioning parts for positioning the thumb, the middle finger and the index finger of a user, so as to combine points of force exertion for the thumb, the middle finger and the index finger via the positioning parts and enable the ring finger and the little finger to curl behind the middle finger, so that the user can master a correct pen-holding posture with the pen-holding corrective-apparatus, whereby the user's fingers can curl naturally without touching the palm when the user holds a writing tool.

### BACKGROUND OF THE INVENTION

1) Field of the Invention

The invention relates to a pen-holding posture corrective apparatus, in particular, to an apparatus that enables a user to learn how to correctly hold a pen for writing without suffering from fatigue and possible injury due to improper pen-holding posture.

2) Description of the Prior Art

Typically, a conventional writing tool, such as a ball-point pen, pencil, fountain pen, marker, dip-pen, artist's pen, or mapmaker's pen has a cylindrical shaft with very small arc. So, when a user holds the pen too tightly for a long time, a deep-groove mark is left on the distal joint (the joint that is farthest from the palm) of the middle finger, or even calluses formed on the middle finger and/or the thumb. Furthermore, the shaft of the writing tool is thin and round, the user tends to grip the shaft with greate strength to prevent the shaft from slipping backwards during use, resulting bending, tilting and deformation of the index finger.

A correct pen-holding posture is an essential first step in a variety of learning processes for the children. However, parents seldom pay much attention to fundamental learning process, causing many to adapt to incorrect pen-holding posture and writing habits since their young age. Most of the incorrect pen-holding posture invloves an occupied palm, improperly manipulating fingers, overly tensed finger joints in a right angled manner, gripping the shaft with the finger tips, writing with excessive strength, and so on as shown in FIGS. 1A and 1B. As a result, any incorrect pen-holding habit easily puts pressure on a user, particularly a child, and makes the user feeling discomfortable, as well as fatigue in bone and muscle, and even injury. Furthermore, an improper pen-holing posture may result a learning barrier for a child who feels a strong antipathy towards writing and learning.

To resolve the above problems, a pen-holding trainer 10 is proposed. As shown in FIGS. 2A and 2B, the conventional pen-holding trainer 10 includes arc-shaped grooves 10a to be gripped by the fingers, pads 10b formed above the arc-shaped grooves 10a, wherein the pads 10b is formed with a notch 10c in which to place a writing tool 100. The pen-holding trainer 10 enables the user to put five fingers on the arc-shaped grooves 10a. However, the grooves 10a are gripped by the middle finger, the ring finger and the little finger in a pen-holding direction, pen-holding causing an incorrect pen-holding posture where the user's middle finger, ring finger, and little finger are tightly grip by the palm.

Even since the ancient time, the correct pen-holding technique has been known to lie in the concepts such as “griping firmly by fingers with the palm unoccupied” and “no fixed rules of holding a pen, except that the pen must be griped steadily and comfortably”. However, neither the user can correct his/her incorrect pen-holding posture nor can the user feel relaxed and comfortable by using the pen-holding trainer 10. As shown in FIG. 2A, the grooves 10a of the pen-holding trainer 10 are merely designed for placing five fingers separately without considering the correct pen-holding posture. So, the user's index finger forms an angle of about 90 degrees in order to grip the shaft. Therefore, the user's index finger may easily get deformed under pressure. Thus, the pen-holding trainer 10 does not provide a proper pen-holding tool for a child, as the child gets tired of holding the pen and dislike writing even more when using the pen-holding trainer 10.

To solve the problems associated with the pen-holding trainer 10, another auxiliary pen-holding trainer 20 disclosed in Taiwan Patent No. 314836 is proposed. As shown in FIGS. 3A and 3B, the auxiliary pen-holding trainer 20 is made up of a pen sleeving tube 21 and two insertion tubes 22 and 23. The pen-sleeving tube 21 is hollow to allow the shaft of a writing tool 100 to sleeve through, whereas the two insertion tubes 22 and 23 are designed for positioning by insertion of distal sections of the index finger and middle finger, wherein the distal section is the portion of the finger farthest from the root of the finger. That is, beginning from the portion connecting the palm, the section of the finger connecting the palm is a proximal section, followed by a middle section and a distal section. Generally, Except that the thumb has only two finger sections (proximal and distal sections), other four fingers have three finger sections (proximal, middle and distal sections) each.

The auxiliary pen-holding trainer 20 enables insertion of the user's middle finger in the insertion tube 22 and another insertion tube 23 with a bending angle, wherein an opening 23a is formed at the middle section of the insertion tube 23 to accommodate bending of the middle finger joint so as to lean against the shaft. However, due to different finger and joint sizes of different users user's fingers and joints may get stuck inside the insertion tubes 22 and 23, which are too small when the fingers are inserted and removed from the insertion tubes 22 and 23. Moreover, if the insertion tubes 22 and 23 are too large compared to the user's finger sizes, not only are the insertion tubes difficult to grip, but the fingers also can not be positioned with certainty in the insertion tubes 22 and 23, making it difficult to do any writting.

As shown in FIG. 3B, the said auxiliary pen-holding trainer 20 merely positions the index finger and the middle finger. Therefore, other fingers are not positioned to maintain the correct pen-holding posture of “griping firmly by fingers with the palm unoccupied”. In addition, the thumb finger part grips the writing tool 100 at the position far away from the pen-tip and against the pen tube. Therefore, when the auxiliary pen-holding trainer 20 is used, a user has to hold the palm tightly with fingers, leading to overtension for the finger joints and energy wasting postures where the shaft is held by the user's fingertips. As a result, the user cannot loosen up his/her finger muscles and bones and easily gets muscles fatigue.

To solve the drawbacks of the said apparatus, another pen-holding trainer disclosed in Taiwan Patent No. 454705 is proposed. As shown in FIG. 4, the pen-holding trainer 30 includes a hollow cylindrical object with opened-ends 31 on both sides for a writing tool 100 to penetrate through. There are a plurality of poistioning points 32 and shifting bodies 33 formed on the surface of the pen-holding trainer 30 for moving and positioning the fingers.

However, the pen-holding trainer 30 merely enables the thumb, the index finger and the middle finger to be positioned, but muscles and bones of the ring finger and little finger are not be kept in correct postures, respectively. So, the user's ring finger and the little finger have to tightly grip the palm as shown in FIG. 4B. For this reason, a user is likely to feel muscle fatigue and joint stiffness when the pen-holding trainer 30 is used to learn writing. Therefore, the pen-holding trainer does not completely solve conventional problems discussed above.

Moreover, the positioning points 32 of the pen-holding trainer 30 are merely designed for positioning the user's fingers without taking the ergonomic factors into consideration. Therefore, the user easily feels pain on the finger against the poisitioning points 32 after writing for a certain time period. In addition, the hollow part of the pen-holding trainer 30 only hold writing tools of certain sizes, of the pen-holding trainer 30 is not applicable to a variety of writing tools.

Furthermore, when both of the pen-holding trainer 30 and the writing tool 100 are assembled together, the three wing-shaped shifting bodies 33 of the pen-holding trainer 30 make the whole assembly inconvenient to be stored in a container or pocket to be carried around. Hence, the pen-holding trainer 30 neither provides a user with a correct pen-holding posture, nor is convenient to be stored and carried.

Moreover, the prior arts discussed above do not remind the user when the pen is held in an incorrect posture. And if the user does not hold the pen according to a correct posture, the locations for positioning the fingers still do not help to improve user's incorrect pen-holding postures, such as wrong manipulation of the fingers, exertion of excessive force, and so. As a result, the user is still unfamiliar with the correct pen-holding posture.

In view of the foregoing, a design of the pen-holding corrective apparatus that is suitable for different age, gender and handed users to correct their pen-holding postures and to master a writing tool correctly, comfortably, freely and easily in conformity with the pen-holding principle of “griping firmly by fingers with the palm unoccupied” has become a subject to be solved.

### SUMMARY OF THE INVENTION

In view of the foregoing, an object of the invention is to provide a pen-holding posture corrective apparatus to enable a user to learn how to correctly hold a pen for writing without suffering from fatigue and possible injury due to improper pen-holding posture.

Another object of the invention is to provide a pen-holding posture corrective apparatus with sensing effect to sense an improper grip or overtightly grip from a user and promoptly remind the user to improve his/her penholding posture.

One other object of the invention is to provide a pen-holding posture corrective apparatus which sense an incorrect writing posture where the user's head passes a correct visible distance away from a writing surface, in order to remind the user with the correct writing posture.

And yet another invention is to provide a pen-holding posture corrective apparatus to enable a user to correctly hold a pen with proper strength without using excessive force to grip and write.

In accordance with the above and other objectives, the present invention proposes a pen-holding posture corrective apparatus to eliminate fatigue and possible injury due to improper pen-holding posture. According to one preferred embodiment of the invention, the pen-holding posture corrective apparatus comprises a main body to be held in a palm of the user; a supporting part formed on top of the main body for supporting against a gap between thumb and index finger of the user; a first poisitioning part formed on a side of the main body for positioning the user's thumb thereto; a second positioning part formed on another side of the main body for positioning a writing tool thereto; a third poisitioning part formed on a side of the second positioning part distant from the main body for positioning the middle finger thereto; a fourth poisitioning part formed in between the second and third positioning parts for positioning the index finger thereto; and a holding part formed on a side of the third positioning part distant from the second positioning part to enable natural curling of the ring finger and the little finger.

The force exertion points for the user's thumb, middle finger and index finger are combined via the first, third and fourth positioning parts, while the user's ring finger and little finger curl behind the middle finger, so that the user can master a correct pen-holding posture with the pen-holding posture corrective apparatus, whereby the user's fingers can curl naturally without touching the palm when the user holds a writing tool. Therefore, the user's palm remains unoccupied when the writing tool is held.

As the pen-holding posture corrective apparatus enables user's fingers to curl naturally without touching the palm when the writing tool is held, the user's palm is unoccupied and the fingers are exercised in a relaxed and accurate manner, so as to resolve drawbacks associated with the prior art. Therefore, the user can relax his/her hand muscle and bone to lessen the fatigue by using the pen-holding posture corrective apparatus, which is also applicable to writing tools of different sizes.

According to another embodiment of the invention, the pen-holding posture corrective apparatus is mounted on a forepart of the writing tool. The pen-holding posture corrective apparatus comprises a first poisitioning part formed on a side of the forepart for positioning the user's thumb; a second poisitioning part formed on a side of the first poisitioning part for positioning the user's index finger; a third poisitioning part formed on a side of the second poisitioning part away from the first poisitioning part for positioning the user's middle finger; and a plurality of sensing components. The sensing components are formed respectively in the first poisitioning part, the second poisitioning part and the third poisitioning part to sense and promptly remind the user when of the first, second and third positioning parts are held over-tightly with the user's thumb, middle finger and index finger. Also, the sensor components sense the incorrect writing posture when the user's head passes the correct visible distance of about 25-30 cm away from a writing surface. The pen-holding posture corrective apparatus further comprises at least an anti-slippery structure in one of the first, second and third poisitioning parts to prevent fingers from sliding down and to maintain the correct pen holding posture.

Since the pen-holding posture corrective apparatus mounted at forepart of a writing tool enables the user's fingers to hold the writing tool in a relaxed and natural fashion. As the force exertion points for the user's thumb, middle finger and index finger are combined together, the user can learn the correct pen-holding posture to resolve conventional problem where the user were not reminded for wrong pen-holding posture, thereby the user can promptly find out the problems of wrong pen-holding posture or over-tightly grip which require corrections.

To enable a further understanding of the structural features and the technical contents of the invention, the brief descriptions of the drawings below are followed by the detailed descriptions of preferred embodiments. The invention can be applied to various embodiments by those skilled in the art that various changes in form and detail may be made therein without departing from the spirit and scope of the invention; however, it is to be understood that the preferred embodiments are merely exemplary of the invention that may be embodied in various forms.

### BRIEF DESCRIPTION OF THE DRAWINGS

FIGS. 1A and 1B are schematic diagrams illustrating conventional penholding postures;

FIG. 2A is a schematic diagram illustrating a conventional pen-holding posture corrective apparatus;

FIG. 2B is a schematic diagram illustrating an operating status of implementing the apparatus shown in FIG. 2A;

FIG. 3A is a schematic diagram illustrating another conventional pen-holding posture corrective apparatus;

FIG. 3B is a schematic diagram illustrating an operating status of implementing the apparatus shown in FIG. 3A;

FIG. 4A is a schematic diagram of yet another conventional pen-holding posture corrective apparatus;

FIG. 4B is a schematic diagram illustrating an operating status of implementing the apparatus shown in FIG. 4A;

FIG. 5 is a schematic diagram illustrating a pen-holding posture corrective apparatus according to a first preferred embodiment of the invention;

FIG. 6 is a rear view of the apparatus shown in FIG. 5;

FIG. 7 is a schematic diagram illustrating an operating status of implementing the pen-holding posture corrective apparatus according to the first embodiment of the invention

FIG. 8 is a schematic diagram illustrating the pen-holding posture corrective apparatus according to a second embodiment of the invention;

FIG. 9 is a rear view of the apparatus shown in FIG. 8;

FIG. 10 is a schematic diagram illustrating an operating status of implementing the pen-holding corrective apparatus according to the second embodiment of the invention; and

FIG. 11 is a schematic diagram illustrating the pen-holding corrective apparatus according to a combination of the first and second embodiments of the invention.

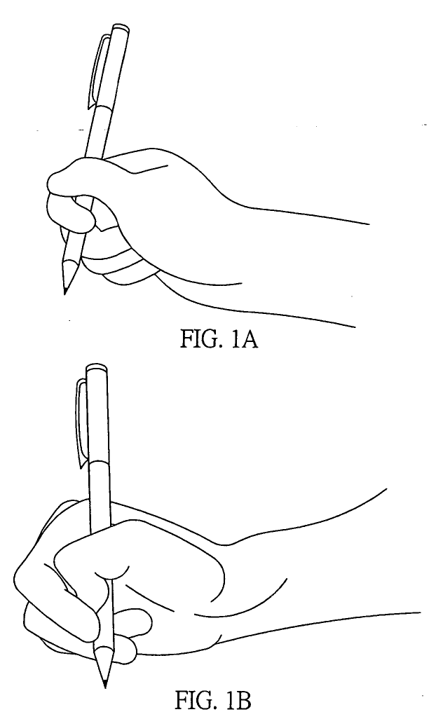

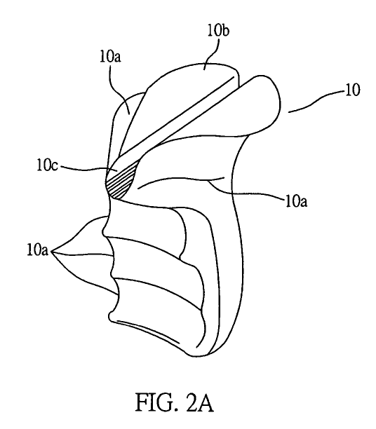

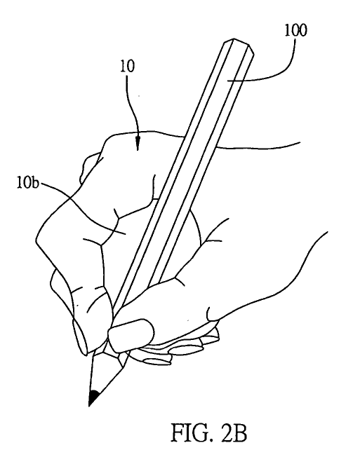

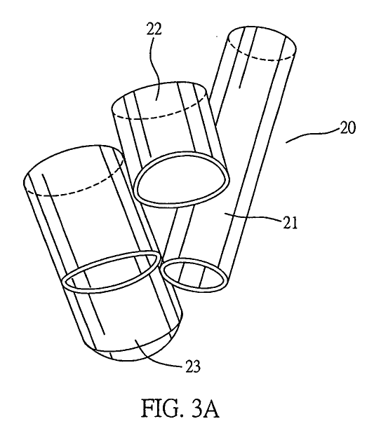

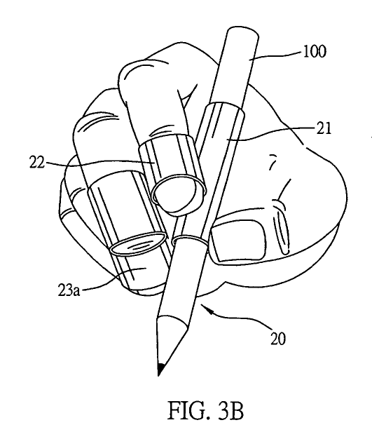

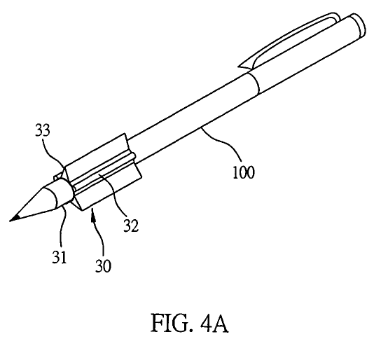

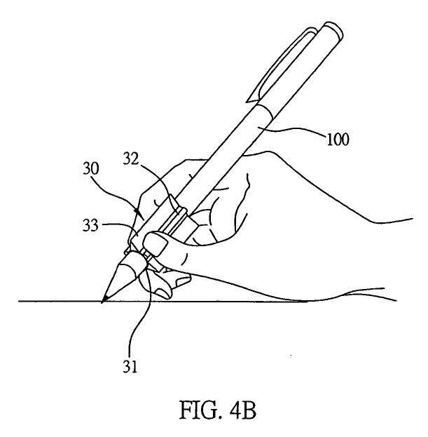

### DETAILED DESCRIPTION OF THE PREFERRED EMBODIMENTS

Preferred embodiments are provided below to further describe viewpoints of the invention. However, the scope of the invention should not be limited by any viewpoint below.

### Embodiment 1

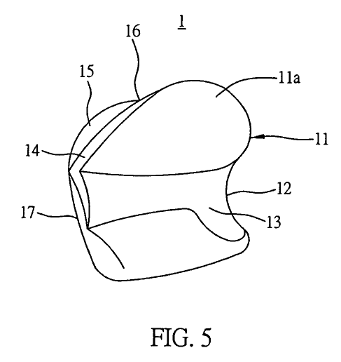

FIGS. 5 through to 7 are schematic diagrams illustrating the pen-holding posture corrective apparatus 1 according to the first embodiment of the invention. As shown in the diagrams, the pen-holding posture corrective apparatus 1 comprises a main body 11, a supporting part 12, a first poisitioning part 13, a second poisitioning part 14, a third poisitioning part 15, a fourth poisitioning part 16, and a pen-holding part 17. The present embodiment of the invention is described with the user holding a writing tool 100 by his/her right hand as an example to apply the present invention, and only the posture corrective apparatus applicable to right hand holding the writing tool 100 is illustrated. However, it should be understood that the pen-holding posture corrective apparatus of the invention is also applicable to left-handed users as long as the pen-holding posture corrective apparatus 1 is designed correspondingly to suit the left hand holding the writing tool 100. The pen-holding posture corrective apparatus 1 shown in the first embodiment can be made of a counterpart that is in opposite direction for a left hand to grip the writing implement 100. The disclosed invention is suitable for both left-handed and right-handed users with ordinary hand structures. Therefore, to simplify and clarify the characteristics and structures of the invention, the preferred embodiments depicted hereafter are merely examplory of using a right hand to take a pen grip.

As shown in the figures, the main body 11 is designed for a user to grip in the center of the palm. The main body 11 in the first embodiment has a main body surface 11 a in almond-eyed shape for a gap between the thumb and the index finger to rest against the smooth curved end thereof. Therefore, both fingers (i.e., the thumb and the index finger) are able to rest against the main body surface 11 a towards the taper end.

Since size of the main body 11 can be varied depending on user's age, gender and handedness (by using either left hand or right hand) or other needs, different categories of the main body 11 that suit to different users can be manufactured according to the above and other needs in the actual implementation. As a result, the main body are adapted to be used by users, such as pre-school children, primary school students, secondary school students, adults, males, females, left-handed persons, and so on.

The supporting part 12 is an arc-shaped structure extending downward from the top of the main body 11 for leaning against a gap between index finger and thumb of the user. Although the supporting part 12 is the arc-shaped structure formed downward from the top of the main body 11, it is noted that the supporting part 12 should not be limited as such, since the anchoring part 12 can be optionally designed as concave shaped or other appropriate shaped structure.

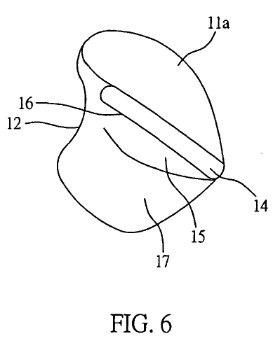

The first poisitioning part 13 is formed on a side of the main body 11 for positioning the thumb of the user thereto. As shown in FIGS. 5 and 6, the first poisitioning part 13 is a concaved structure coupled to the supporting part 12. When the thumb of the user is positioned at the first poisitioning part 13, the distal thumb joint can grip a forepart 100a of the writing tool 100, such that the distal section of the thumb is positioned on a shaft of the writing tool 2-3 cm away from the tip of the forepart 100a. Therefore, the thumb of the user can lean against the supporting part 12 smoothly and easily towards the taper end via the first poisitioning part 13.

The second poisitioning part 14 is formed on another side (opposite to the side of the main body where the first positioning part is formed) of the main body 11 for positioning the writing tool 100. As shown in the diagrams, the second poisitioning part 14 is a concaved structure coupled to a location of the leaning part 12 away from the first poisitioning part 13. When the writing tool 100 is placed in the second poisitioning part 14, the writing tool 100 can be kept tilted at a angle of 45 degrees and above with respect to a writing paper surface. The writing tool 100 can be chosen from either a ball-point pen, a pencil, a fountain pen, an imprinted pen, a marker, a sketching art pen, a dip-pen, a mapmaker's pen, or other writing tools with equivalent functions. In addition, the writing tool can be made in various shapes such as a round shape, a polygonal shape, etc. Although the second poisitioning part 14 in the present embodiment is merely illustrated as a concaved structure, the structure of the second poisitioning part 14 should not be limited as such. The structure of the second positioning part can be modified depending on the needs as long as the writing tool 100 can be kept tilted at a angle of about 45-degree with the writing paper surface.

The third poisitioning part 15 is formed on a side of the second poisitioning part 14 away from the main body 11 for positioning the middle finger thereto. As shown in the diagrams, the third poisitioning part 15 is a concaved structure coupled to the supporting part 12. When the user positions the middle finger to the third poisitioning part 15, a left side of the distal section of the middle finger leans against the writing tool 100. Therefore, the user can lean the middle finger againt the main body surface 11a towards the taper end via the third poisitioning part 15. The embodiment is merely exemplary with a right hand user, so the left side of the distal section of the middle finger leans against the writing tool 100. If the pen-holding posture corrective apparatus is used by a left-handed user, a right side of the distal section of the user's middle finger should lean against the writing tool 100. In other words, the pen-holding posture corrective apparatus is suitable for either a right-handed or a left-handed person.

The fourth poisitioning part 16 is formed between the second poisitioning part 14 and the third poisitioning part 15 for positioning the index finger thereto. As shown in the diagrams, the fourth poisitioning part 16 is slightly curved to enable the distal section of the user's index finger to grip the shaft of writing tool 100 at a distance of 2-3 cm away from the tip of the forepart 100a. When the writing tool 100 is positioned in the second poisitioning part 14, the apparatus enables a rearpart 100b of the writing tool 100 is optionally leaned on a proximal joint side of the user's index finger positioned to the fourth poisitioning part 16. The proximal joint side is the first finger joint at the root of the finger joining the palm (i.e the palm joining portion), followed by the middle finger joint and the distal finger joint in sequence. Generally, all fingers have three finger joints each, except that a thumb has two finger joints (proximal and distal joints).

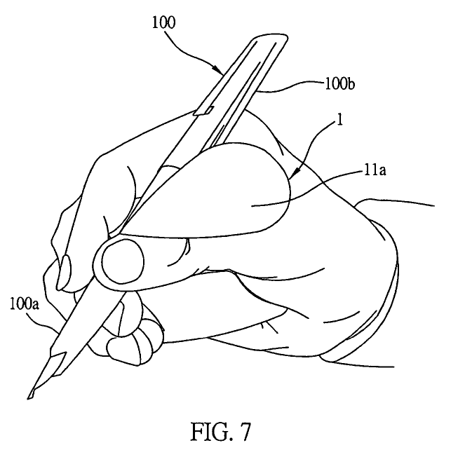

The pen-holding part 17 is on a side of the third poisitioning part 15 away from the second poisitioning part 14 for enabling the ring finger and the little finger to curl naturally when the user is holding the writing tool. As shown in FIG. 7, both of the ring finger and the little finger curl behind the middle finger. In addition, the penolding posture corrective apparatus combines the force exertion points for the distal joint of the user's thumb, the left side of the distal finger joint of the user's middle finger and the distal section of the index finger together via the first poisitioning part 12, the third poisitioning part 15 and the fourth poisitioning part 16, such that the user's fingers curl naturally like a bunch of five bananas.

The pen-holding posture corrective apparatus 1 in the embodiment enables the distal section of the thumb and the distal section of the index finger to position on the shaft 2-3 cm away from the tip of the forepart 100a via the first poisitioning part 13 and the fourth poisitioning part 16. Moreover, the pen-holding posture corrective apparatus 1 enables the left side of the distal section of the middle finger to lean against the shaft by the third poisitioning part 15, so that the ring finger and the little finger can easily curl in a relaxed manner behind the middle finger, so that the user's fngers are adapted to the correct pen-holding posture with the penhlding posture corrective apparatus 1 with the palm unoccupied when the writing tool 100 is held, so that the user's five fingers curl with the palm to form a “cabinet-like” space inbetween.

As the penholding posture of a user is corrected through use of the pen-holding posture corrective apparatus in the embodiment, the user's muscle and bone movements are adapted to a correct and relaxed posture after a period of time. In other words, the user's penholding posture is like holding a racket by an athlete to play a ball game. The movement command sent from the brain is precisely transmitted to hand holding the raquet. Similarly, it is like a pianist playing the piano based on his/her muscle reflex without looking at the music book after he/she is familiar with piano fingering. Therefore, the pen-holding posture corrective apparatus provides the ideal pen-holding posture for a user to correct the current pen-holding posture, so as to write easily and correctly without causing fatigue and pain to the fingers.

### Embodiment 2

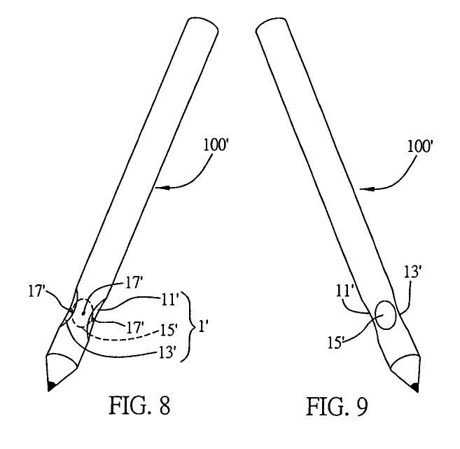

FIGS. 8 through to 10 are schematic diagrams illustrating a pen-holding posture corrective apparatus 1′ according to the second embodiment of the invention. As shown in the diagrams, the pen-holding posture corrective apparatus 1′ is mounted on a forepart 100a′ of a writing tool 100′. The pen-holding posture corrective apparatus 1′ comprises a first poisitioning part 11′, a second poisitioning part 13′, a third poisitioning part 15′ and a plurality of sensor components 17′. The pen-holding posture corrective apparatus 1′ has the similar function to the pen-holding posture corrective apparatus 1 illustrated in the first embodiment, so the similar functions will not be described further. The description in the second embodiment only focuses on structures and functions different from the first embodiment to provide a better understanding of the features and advantages of the invention.

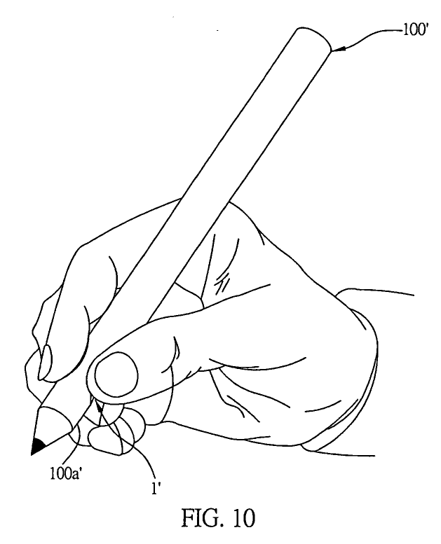

As shown in FIGS. 8 and 9, the first poisitioning part 11′ is formed on a side of the forepart 100a′ for positioning the user's thumb. The first poisitioning part 11′ is a shallow groove for accomodating the distal section of the user's thumb. The second poisitioning part 13′ is formed on a side of the first poisitioning part 11′ for positioning the index finger thereto. As shown in the diagram, the second poisitioning part 13′ is a shallow groove for accomodating the distal section of the index finger. The third poisitioning part 15′ is formed on a side of the second positioning part 13′ away from the first poisitioning part 11′ for positioning the middle finger thereto. The third poisitioning part 15′ is a shallow groove for acomodating the left side of the distal section of the user's middle finger.

The first poisitioning part 11′, the second poisitioning part 13′ and the third poisitioning part 15′ illustrated in the second embodiment are all made up of the shallow grooves; however, it should be understood that the first poisitioning part 11′, the second poisitioning part 13′, and the third poisitioning part 15′ can be made of other structures for respectively positioning the user's thumb, index finger and middle finger. For example, the first poisitioning part 11′, the second poisitioning part 13′ and the third poisitioning part 15′ can be made of structures to correspond with respective shapes of the user's thumb, index finger and middle finger. In other words, the shapes of the first, second and third poisitioning parts 11′, 13′ and 15′ may vary as long as the the first, second and third poisitioning parts 11′, 13′ and 15′ can position the thumb, the index finger and the middle finger, and the distal section of the thumb, the distal section of the index finger and the left side of the distal section of the middle finger are positioned on the shaft 2-3 cm away from the tip of the forepart 100a′.

The plurality of sensor components 17′ are correspondingly formed in the first poisitioning part 11′, the second poisitioning part 13′ and the third poisitioning part 15′ for sending out signals to remind the user when either the first poisitioning part 11′, the second poisitioning part 13′ or the third poisitioning part 15′ is gripped with excess strength by the thumb, the middle finger and the index finger. The plurality of sensor components 17′ can be made up of a combination of common pressure sensors, with other suitable components such as indicator lights, bussers and so on, so that a warning signal or sound can be sent out to promptly remind the user when either the first poisitioning part 11′, the second poisitioning part 13′, or the third poisitioning part 15′ is held by excess strength. Also, the warning signal or sound is issued when the sensor components 17′ sense an incorrect writing posture where the user's head passes a correct visible distance of about 25-30 cm away from a writing surface, such as table, desk, writing board, books, papers, or any writable objects. For example, as the user adapts the incorrect writing posture with his/her eyes too close to the writing surface or with his/her head leaned against the writing surface, the pressure sensor would sense the user's head and activate the buzzers or indicator lights for sending out signals that warn the user for his/her wrong writing posture. Accordingly, the pen-holding posture corrective apparatus having the sensor components can help the user to establish a correct writing habit, and prevent the user from acquiring short-sightness from bad writing habits. Since components such as pressure sensors, indicator lights, and buzzers and mechsniams thereof are well known to those skilled in the art, the details related to these components and mechanisms are omitted herein.

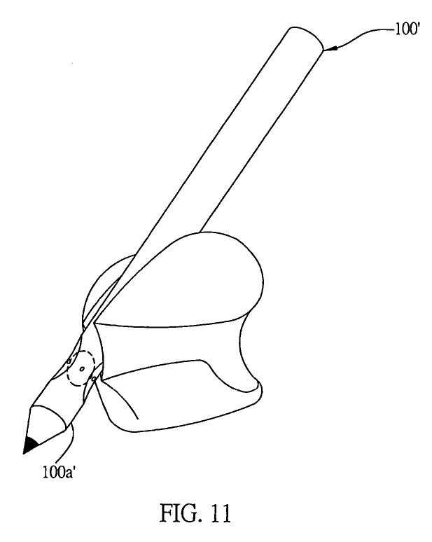

As shown in FIG. 10, the pen-holding posture corrective apparatus 1′ in the second embodiment is mounted on the forepart 100a′ of the writing tool 100′ enabling the user's fingers to hold the pen in a natural and relaxed manner, so as to correct the penholding posture for the user. As shown in FIG. 11, the pen-holding posture corrective apparatus 1′ in the second embodiment may be used simultaneously with the pen-holding posture corrective apparatus 1 described in the first embodiment to achieve the optimal corrective effect on the penholding posture for the user. As the pen-holding posture corrective apparatuses 1 and 1′ separately, a user can choose to start with the pen-holding posture corrective apparatus 1 of the first embodiment for a certain time period of use, and then shift to use the pen-holding posture corrective apparatus 1′. Accordingly, the user's penholding posture can be gradually corrected. In other words, the pen-holding posture corrective apparatus 1′ illustrated in the second embodiment and the pen-holding posture corrective apparatus 1 described in the first embodiment can be used either simultaneously or separately and implementing mode should not be limited as such described above.

The pen-holding posture corrective apparatus 1′ is further formed with an anti-slippery structure (not shown), which can be made in shape of a staircase, a loop, a roughened surface or other appropriate structure to avoid the user's finger from slipping down during writing. The first poisitioning part 11′, the second poisitioning part 13′ and the third poisitioning part 15′ of the pen-holding posture corrective apparatus 1′ are equipped with the anti-slippery function. The anti-slippery structure is only an additional design serve to reinforce the anti-slippery effect, not a critical condition that constitutes the invention. Since the pen-holding posture corrective apparatus 1′ does not contain any protruding structurepen-holding to create trouble in terms of storage and carriage when combined with the writing tool 100′, pen-holding this solves the drawbacks associated with prior art.

Moreover, the pen-holding posture corrective apparatus 1′ illustrated in the second embodiment is formed as a one-piece structure at the forepart 100a′ of the writing tool 100′, it should be noted that the pen-holding corrective apparatus 1′ can optionally be an additional structure formed at the forepart 100a′ of the writing tool 100′ to enable application to different writing tools 100′.

Therefore, by applying the pen-holding posture corrective apparatus of the invention, the force exertion points for the user's thumb, middle finger and index finger are combined together to allow the user to learn the correct penholding posture, so as to solve problems, such as poor correction effect and inconvenience associated with the prior art. In addition, the invention can promptly reminds the user when the penholding posture is incorrect or excess strength is used to hold the pen during writing.

The plurality of sensor components 17′ in the second embodiment are provided to send out a signal to remind the user of incorrect pen-holding posture. Similarly, the sensor components can also be installed in the pen-holding posture corrective apparatus of the first embodiment. It is understood that the embodiments described herein are merely illustrative of the principles of the invention and that a wide variety of modifications thereto may be effected by persons skilled in the art without departing from the spirit and scope of the invention as set forth in the following claims.

1. A pen-holding posture corrective apparatus, comprising:
a main body, held by a user's palm;
a supporting part, formed on top of the main body for supporting against a gap between thumb and index finger of the user;
a first poisitioning part, formed on a side of the main body for positioning a distal section of the thumb thereto;
a second poisitioning part, formed on another side of the main body for positioning a writing tool thereto;
a third poisitioning part, formed on a side of the second poisitioning part away from the main body for positioning a left lateral part of distal section of the user's middle finger thereto;
a fourth poisitioning part, formed between the second poisitioning part and the third poisitioning part for positioning a distal section of the index finger thereto; and
a pen-holding part, formed on a side of the third poisitioning part away from the second poisitioning part, enabling the ring finger and the little finger of the user to bend naturally; the first poisitioning part, the third poisitioning part and the fourth poisitioning part enabling the strengths of the thumb, the middle finger and the index finger to be combined together.

2. The pen-holding posture corrective apparatus of claim 1, wherein the main body has an almond-eyed shaped surface.

3. The pen-holding posture corrective apparatus of claim 1, wherein the main body is further formed with a plurality of sensor components.

4. The pen-holding posture corrective apparatus of claim 3, wherein the plurality of sensor components are made up of pressure sensors and indicator lights.

5. The pen-holding posture corrective apparatus of claim 3, wherein the plurality of sensor components are made up of pressure sensors and buzzers

6. The pen-holding posture corrective apparatus of claim 1, wherein the first poisitioning part is a concave shaped structure coupled to the supporting part.

7. The pen-holding posture corrective apparatus of claim 1, wherein the second poisitioning part is a concave shaped structure coupled to a portion of the supporting part away from the first positioning part.

8. The pen-holding posture corrective apparatus of claim 1, wherein the third poisitioning part is a concave shaped structure coupled to the supporting part.

9. The pen-holding posture corrective apparatus of claim 1, wherein the fourth poisitioning part is a convex shaped structure.

10. A pen-holding posture corrective apparatus mounted at a forepart of writing tool, the pen-holding posture corrective apparatus comprising:
a first poisitioning part, formed on a side of the forepart for positioning a distal section of a user's thumb;
a second poisitioning part, formed on a side of the first poisitioning part for positioning a distal section of the user's index finger;
a third poisitioning part, formed on a side of the second poisitioning part away from the first poisitioning part for positioning a left lateral part of distal section of the user's middle finger thereto; and
a plurality of sensing components, formed respectively in the first poisitioning part, the second poisitioning part and the third poisitioning part for sensing and sending out a reminding signal when the first poisitioning part, the second poisitioning part and the third poisitioning part are held over-tightly with the user's thumb, index finger and middle finger.

11. The pen-holding posture corrective apparatus of claim 10, wherein the first poisitioning part is a shallow groove.

12. The pen-holding posture corrective apparatus of claim 10, wherein the second poisitioning part is a shallow groove.

13. The pen-holding posture corrective apparatus of claim 10, wherein the third poisitioning part is a shallow groove.

14. The pen-holding posture corrective apparatus of claim 10, wherein the plurality of sensor components are made up of pressure sensors and indicator lights.

15. The pen-holding posture corrective apparatus of claim 10, wherein the plurality of sensor components are made up of pressure sensors and buzzers.

16. The pen-holding posture corrective apparatus of claim 3, wherein the plurality of sensor components are further provided for sensing a writing posture of the user and reminding the user when the user's head passes a correct visible distance away from a writing surface.

17. The pen-holding posture corrective apparatus of claim 16, wherein the correct visible distance is about 25-30 cm.
